(19) United States
(12) Patent Application Publication
(10) Pub. No.: US 2019/0135042 A1
(43) Pub. Date: May 9, 2019

(54) Pneumatic Tire, Having Working Layers Comprising Monofilaments And A Tire Tread With Grooves

(71) Applicant: COMPAGNIE GENERALE DES ETABLISSEMENTS MICHELIN, Clermont-Ferrand (FR)

(72) Inventors: Aymeric BONNET, Clermont-Ferrand Cedex 9 (FR); Jacques MOREL-JEAN, Clermont-Ferrand Cedex 9 (FR); Jean-Charles DEROBERT-MAZURE, Clermont-Ferrand Cedex 9 (FR)

(21) Appl. No.: 16/099,079

(22) PCT Filed: May 10, 2017
(86) PCT No.: PCT/FR2017/051108

§ 371 Date: Nov. 5, 2018

(30) Foreign Application Priority Data
May 10, 2016 (FR) 16/54145

(51) Int. Cl. B60C 11/03; B60C 9/00; B60C 9/20

(52) U.S. Cl. CPC B60C 11/0302; B60C 11/0304; B60C 9/0007; B60C 9/0042; B60C 9/0064; B60C 9/2009; B60C 2009/2214; B60C 2009/2019; B60C 2009/2051; B60C 2009/2077; B60C 2009/208; B60C 2009/2083; B60C 2009/209; B60C 2009/2016

(57) ABSTRACT

Technique to increase the endurance of tires comprising two working layers (41, 42), comprising mutually parallel reinforcing elements (411, 421) each forming, with the circumferential direction (XX′) of the tire, an oriented angle (AA, AB), such that these respective angles are of opposite sign, the reinforcing elements being comprised of individual metal threads, by combining a manufacturer-recommended direction of rotation (SR) and an optimized design of tread pattern. The tire also comprises axially exterior major grooves (24) in the tread (2) having a mean linear profile L of a width W at least equal to 1 mm and of a depth D at least equal to 5 mm. Different conditions governing the angular orientations of the mean linear profiles L of the axially exterior major grooves (24) apply to the left-hand axially exterior portion (22) and to the right-hand axially exterior portion (23) of the tread (2).

### FIELD OF THE INVENTION

The present invention relates to a passenger vehicle tire, and more particularly to the crown of such a tire.

It is possible for the manufacturer to recommend a direction of rotation for the tire with a view to optimizing the performance, particularly the grip performance, thereof. This direction of rotation is referred to as the recommended direction of rotation. In order to indicate the recommended direction of rotation, the manufacturer moulds an arrow into the sidewall of the tire, to indicate this direction of rotation. The user preferably positions all his tires in such a way that the rotation of the tires in the recommended direction of rotation causes the vehicle to move when running forwards, in the direction known as the direction of forward travel.

In the present document, according to customary notation, any pair of letters in bold type indicates a vector.

Since a tire has a geometry that exhibits symmetry of revolution about an axis of rotation YY′, the geometry of the tire is generally described in an anticlockwise cylindrical frame of reference (0, XX′, YY′, ZZ′). The architecture of the tire is described by a meridian plane (0′, YY′, ZZ′) containing the axis of rotation of the tire. For a given meridian plane, the radial, (ZZ′), axial (YY′) and circumferential (XX′) directions respectively denote the directions perpendicular to the axis of rotation of the tire in the median plane in question, parallel to the axis of rotation of the tire and perpendicular to the meridian plane. O, the centre of the frame of reference, is the intersection of the axis of rotation and of the circumferential median plane referred to as the equator that divides the tire into two substantially symmetrical torus shapes, it being possible for the tire to exhibit asymmetries of the tread, of architecture which are connected with the manufacturing precision or with the sizing. In the frame of reference as used in the remainder of the description, the vector XX′ is always in the recommended direction of rotation, and ZZ′ is in a centrifugal direction. The direction of the vector YY′ is deduced from the predefined directions of XX′ and ZZ′, in such a way that the frame of reference (0, XX′, YY′, ZZ′) is an anticlockwise frame of reference. The half-torus situated in the space of the axial YY′-positive coordinates in this frame of reference (O, XX′, YY′, ZZ′) is referred to as the left-hand half torus or left-hand part (PG). The half-torus situated in the space of the Y-negative axial coordinates is referred to as the right-hand half torus or right-hand part (PD).

In the following text, the expressions “radially on the inside of” and “radially on the outside of” mean “closer to the axis of rotation of the tire, in the radial direction, than” and “further away from the axis of rotation of the tire, in the radial direction, than”, respectively. The expressions “axially on the inside of” and “axially on the outside of” mean “closer to the equatorial plane, in the axial direction, than” and “further away from the equatorial plane, in the axial direction, than”, respectively. A “radial distance” is a distance with respect to the axis of rotation of the tire and an “axial distance” is a distance with respect to the equatorial plane of the tire. A “radial thickness” is measured in the radial direction and an “axial width” is measured in the axial direction.

A tire comprises a crown comprising a tread that is intended to come into contact with the ground via a tread surface of which the part in contact with the ground is referred to as the contact patch. A tire also comprises two beads that are intended to come into contact with a rim, and two sidewalls that connect the crown to the beads. Furthermore, a tire comprises a carcass reinforcement, comprising at least one carcass layer, radially on the inside of the crown and connecting the two beads.

The tread of a tire is delimited, in the radial direction, by two circumferential surfaces of which the radially outermost is referred to as the tread surface and of which the radially innermost is referred to as the tread pattern bottom surface. In addition, the tread of a tire is delimited, in the axial direction, by two lateral surfaces. The tread is also made up of one or more rubber compounds. The expression “rubber compound” refers to a composition of rubber comprising at least one elastomer and a filler.

The crown comprises at least one crown reinforcement radially on the inside of the tread. The crown reinforcement comprises at least one working reinforcement comprising at least one working layer made up of mutually parallel continuous reinforcing elements that form. with the circumferential direction, an angle of between 15° and 50°. The crown reinforcement may also comprise a hoop reinforcement comprising at least one hooping layer made up of reinforcing elements that form, with the circumferential direction, an angle of between 0° and 10°, the hoop reinforcement usually, although not necessarily, being radially on the outside of the working layers. Each reinforcing element has two ends which are the axially outermost points of the reinforcing element.

In a tire that has a direction of rotation recommended by the manufacturer, mounted in accordance with the manufacturer recommendations, rotating in this direction, a reinforcing element of a working layer always enters the contact patch from the same end, referred to as the leading end E1, and always leaves the contact patch by the same trailing end E2. If the trailing end E2 of a reinforcing element of a working layer lies in the left-hand half-torus and its leading end E1 lies in the right-hand half-torus, then the working layer is said to be right-handed. Conversely, if the trailing end E2 lies in the right-hand half-torus and the leading end E1 lies in the left-hand half-torus, then the working layer is said to be left-handed. In a frame of reference oriented in the anticlockwise direction as defined hereinabove (0, XX′, YY′, ZZ′), for a left-handed working layer, the angle (XX′; E2E1) between the circumferential axis and a reinforcing element is positive. For a right-handed working layer, the angle (XX′; E2E1) between the circumferential axis and a reinforcing element is negative.

In order to obtain good grip on wet ground, cuts are made in the tread. A cut denotes either a well, or a groove, or a sipe, or a circumferential groove and forms a space opening onto the tread surface. A well has, at the tread surface, an open-end cross section that is generally substantially polygonal or circular. A sipe or a groove has, at the tread surface, an open-end cross section that has two characteristic main dimensions: a width W and a length Lo, such that the length Lo is at least equal to twice the width W. A sipe or a groove is therefore delimited by at least two main lateral faces determining its length Lo and connected by a bottom face, the two main lateral faces being distant from one another by a non-zero distance referred to as the width W of the sipe or of the groove.

By definition, a sipe or a groove which is delimited by:
only two main lateral faces is said to be open-ended,
by three lateral faces, two of them being main faces determining the length of the cut, is said to be blind,
by four lateral faces, two of them being main faces determining the length of the cut, is said to be double-blind.

The difference between a sipe and a groove is the value of the mean distance separating the two main lateral faces of the cut, namely its width W. In the case of a sipe, this distance is suitable for allowing the mutually-facing main lateral faces to come into contact when the sipe enters the contact patch in which the tire is in contact with the road surface. In the case of a groove, the main lateral faces of this groove cannot come into contact with one another under usual running conditions. This distance for a sipe is generally, for passenger vehicle tires, at most equal to 1 millimetre (mm). A circumferential groove is a cut of substantially circumferential direction that is substantially continuous over the entire circumference of the tire.

More specifically, the width W is the mean distance, determined along the length of the cut and along a radial portion of the cut, comprised between a first circumferential surface, radially on the inside of the tread surface at a radial distance of 1 mm, and a second circumferential surface, radially on the outside of the bottom surface at a radial distance of 1 mm, so as to avoid any measurement problem associated with the junctions at which the two main lateral faces meet the tread surface and the bottom surface.

The depth of the cut is the maximum radial distance between the tread surface and the bottom of the cut. The maximum value of the depths of the cuts is referred to as the tread depth D. The tread pattern bottom surface, or bottom surface, is defined as being the surface of the tread surface translated radially inwards by a radial distance equal to the tread depth.

### PRIOR ART

In the current context of sustainable development, the saving of resources and therefore of raw materials is one of industry's key objectives. For passenger vehicle tires, one of the avenues of research for achieving this objective is to replace the metal cords usually employed as reinforcing elements in various layers of the crown reinforcement with individual threads or monofilaments as described in document EP 0043563 in which this type of reinforcing element is used with the twofold objective of saving weight and lowering rolling resistance.

However, the use of this type of reinforcing element has the disadvantage of causing these monofilaments to buckle under compression, causing the tire to exhibit insufficient endurance, as described in document EP2537686. As that same document describes, a person skilled in the art proposes a particular layout of the various layers of the crown reinforcement and a specific quality of the materials that make up the reinforcing elements of the crown reinforcement in order to solve this problem.

An analysis of the physical phenomenon shows that the buckling of the monofilaments occurs in the axially outermost parts of the tread underneath the grooves, as mentioned in document JP 2012071791. This region of the tire has the particular feature of being subjected to high compression loadings when the vehicle is running in a curved line. The resistance of the monofilaments to buckling is dependent on the geometry of the grooves, thus demonstrating the surprising influence that the tread pattern has on the endurance of the monofilaments.

### SUMMARY OF THE INVENTION

The key objective of the present invention is therefore to increase the endurance of a tire the working layer reinforcing elements of which are made up of monofilaments, through the design of a tread pattern for the tread that is suited to the direction of rotation recommended by the manufacturer.

This objective is achieved by a tire for a passenger vehicle, intended to be mounted on a rim in a recommended direction of rotation (SR) orientating a circumferential direction (XX′), comprising:
with respect to the circumferential direction (XX′) oriented in the recommended direction of rotation (SR), a left-hand part (PG) and right-hand part (PD) extending axially and symmetrically from a circumferential median plane (XX′, ZZ′), passing through the middle of a tread of the tire, intended to come into contact with the ground via a tread surface, and perpendicular to an axis of rotation of the tire (YY′),
the tread comprising two axially exterior portions, belonging respectively to the left-hand part (PG) and to the right-hand part (PD) of the tire, each respectively having an axial width (LG, LD) at most equal to 0.3 times the axial width LT,
at least one axially exterior portion of the tread comprising axially exterior grooves, an axially exterior groove forming a space opening onto the tread surface and being delimited by at least two main lateral faces connected by a bottom face,
at least one axially exterior groove, referred to as major groove, having a width W, defined by the distance between the two main lateral faces, at least equal to 1 mm, a depth D, defined by the maximum radial distance between the tread surface and the bottom face, at least equal to 5 mm, and a mean linear profile L, having an axially innermost point (a) and an axially outermost point (b) which define the vector (ab) of the mean linear profile L,
the tire further comprising a crown reinforcement radially on the inside of the tread, and comprising a working reinforcement and a hoop reinforcement,
the working reinforcement comprising at least two working layers each comprising reinforcing elements which are coated in an elastomeric material, mutually parallel and respectively form, with a circumferential direction (XX′) of the tire, two oriented angles AA and AB in the counterclockwise direction at least equal to 20° and at most equal to 50°, in terms of absolute value, and of opposite sign from one layer to the next,
the said reinforcing elements in each working layer being made up of individual metal threads or monofilaments having a cross section S the smallest dimension of which is at least equal to 0.20 mm and at most equal to 0.5 mm, and a breaking strength Rm,
the density d of monofilaments in each working layer being at least equal to 100 threads per dm and at most equal to 200 threads per dm,
the hoop reinforcement comprising at least one hooping layer comprising reinforcing elements which are mutually parallel and form, with the circumferential direction (XX′) of the tire, an angle at most equal to 10°, in terms of absolute value,
the vector (ab) of any mean linear profile L of any axially exterior major groove of the left-hand axially exterior portion of the tread forming, with the circumferential direction (XX′) of the tire, an oriented angle C (XX′; ab) at least equal to (85°+(AA+AB)/2)
the vector (ab) of any mean linear profile L of any axially exterior major groove of the right-hand axially exterior portion of the tread forming, with the circumferential direction (XX′) of the tire, an oriented angle C′ (XX′; ab) at most equal to (−85°+(AA+AB)/2),
the breaking strength R_{C} of each working layer is at least equal to 30 000 N/dm, Rc being defined by: Rc=Rm*S*d, where Rm is the tensile breaking strength of the monofilaments in MPa, S is the cross-sectional area of the monofilaments in mm² and d is the density of monofilaments in the working layer considered, in number of monofilaments per dm.

AA and AB are, indifferently, the oriented angles formed by the direction XX′ and the reinforcing elements of the working layers, namely the angles (XX′; E2E1), of the right-handed working layer and of the left-handed working layer. AA and AB are of opposite sign. In many tires, their absolute values are equal.

The intersection of the tread surface with the main lateral faces of a groove determines the main profiles of the groove. The mean linear profile of a groove is calculated by linear interpolation of these main profiles. The linear interpolation is done in the axial direction on the axially outermost portion of the tread considered, it being possible for the groove to be of any shape, curved, sinusoidal, zigzag. The main profiles of the grooves are usually intuitively identifiable because the intersection between the tread surface and the lateral faces of the grooves is a curve. In the case of tires in which the tread surface and the lateral faces of the grooves meet continuously, the profiles of the grooves are determined by the intersection between the main lateral faces of the grooves and the tread surface translated radially by −0.5 mm.

Usually, the main profiles of the groove are substantially of the same shape and distant from one another by the width W of the groove.

For grooves of complex shape, what is meant by the width of the groove is the mean distance between the main lateral faces, averaged over the mean curved length of the main profiles of the groove.

From a mechanical operation standpoint, the buckling of a reinforcing element occurs in compression. It occurs only radially on the inside of the axially outermost portions of the tread because it is in this zone that the compressive loadings are highest in the event of transverse loading. These axially outermost portions each have as their maximum axial width 0.3 times the total axial width of the tread of the tire.

Buckling is a complex and unstable phenomenon which leads to fatigue rupture of an object that has at least one dimension one order of magnitude smaller than a main dimension, such as beams or shells. Monofilaments are objects of this type with a cross section very much smaller than their length. The phenomenon begins when the main dimension of the monofilament is placed under compression. It continues because of the asymmetry of geometry of the monofilament, or because of the existence of a transverse force caused by the bending of the monofilament, which is a stress loading that is highly destructive for metallic materials. This complex phenomenon is notably highly dependent on the boundary conditions, on the mobility of the element, on the direction of the applied load and on the deformation resulting from this load. If this deformation does not take place substantially in the direction of the main dimension of the monofilament, then buckling will not occur and, in the case of monofilaments surrounded by the matrix of rubber compound of the working layers of a tire, the load is absorbed by the shearing of the rubber compound between the monofilaments.

In addition, the buckling of the monofilaments of the working layers occurs only under the axially exterior grooves of the tread because, in the absence of an axially exterior groove, the rubber material of the tread radially on the outside of the reinforcing element absorbs most of the compressive load. Likewise, the axially exterior grooves the depth of which is less than 5 mm have no influence on the buckling of the monofilaments. Therefore, only the axially exterior grooves referred to as major grooves need to be subjected to special design rules when using monofilaments in the working layers. These axially exterior major grooves are particularly essential to the wet grip performance of the tire.

Moreover, the axially exterior grooves the width of which is less than 1 mm, also referred to as sipes, close when they enter the contact patch and therefore protect the monofilaments from buckling. In the case of the grooves that are not axially exterior, the compressive loading in the case of transverse loading of the tire is too low to cause buckling. Moreover, it is common practice in passenger vehicle tires for only sipes of a width less than 1 mm to be arranged in the axially central portions of the tread.

In directions in which no empty space allows for movement, the compressive loadings will be absorbed by the rubber compound. When an axially exterior major groove is present, this groove does not absorb the loads, but rather allows movements in compression in the direction perpendicular to its mean linear profile. In order to avoid buckling, it is necessary for the compressive load not to be applied to the reinforcing element in the direction of its main dimension but to the rubbery material in compression and in shear. For that, it is necessary for the mean linear profile of the axially exterior major grooves present on the axially outermost portions, each having a maximum axial width equal to 0.3 times the axial width of the tread, not to be perpendicular to any of the monofilaments radially on the inside of it, to an angular precision of 10°. With a deviation of more than 10°, the working layer considered absorbs compressive loadings through the shearing of the rubbery material with which the monofilaments are coated.

Specifically, calculations and testing show that a difference of 10° between the angle C of the mean linear profile of an axially exterior major groove and the perpendicular to the monofilament is enough to protect the latter from buckling over the portion of tread considered.

In order to optimize the orientation of the mean linear profile of the axially exterior major grooves, which means to say in order to site them as far as possible away from each of the perpendiculars to the reinforcing elements of the two working layers while maintaining their grip function, which means to say in order not to make them into circumferential grooves, they need to be oriented according to the angle of the bisector of the two perpendiculars, namely about (90°+(AA+AB)/2) mod(180°). With an angle of safety of 10°, it is possible to design axially exterior major grooves that meet the endurance requirements and are such that their mean linear profile forms, with the circumferential axis, an angle in the interval [90+(AA+AB)/2−30; 90+(AA+AB)/2+30] mod(180), which conditions do not vary according to the direction of rotation of the tire.

A more detailed analysis of the running conditions using calculations and testing has made it possible to conceive of an optimized solution based on an imposed direction of rotation of the tire that allows the endurance of the monofilaments to be improved.

The highest compression loadings on the tread pattern and, therefore, on the reinforcing elements of the working layers, occur under cornering with high transverse acceleration. In a left-hand bend, centrifugal force applies to the vehicle a loading that is oriented to the right. The tire that is the most heavily loaded is the one that absorbs the weight transfer, on the front right-hand side of the vehicle. On this tire, the portion that is the most heavily loaded is the one furthest towards the outside of the vehicle, namely the right-hand portion. Likewise, in a right-hand bend, the most heavily loaded tire is the front left-hand tire and, on this tire, the portion that is the most heavily loaded is the one furthest towards the outside of the vehicle, namely the left-hand portion.

If the manufacturer does not recommend any direction of running, any half-torus of the tire may be called upon indifferently to withstand the maximum loadings generated by a right-hand bend or a left-hand bend because it can be rotated on its rim through 180° and positioned on any arbitrary wheel of the vehicle. In this case, the design of the tread pattern needs to take into account all of the possible stress loadings and therefore does not allow optimization according to the angles of each working layer.

By contrast, if a tire has a recommended direction of rotation, provided that the user follows these recommendations, the tire will not be rotated on its rim through 180° with respect to the usual direction of forward travel of the vehicle. It is then possible to choose the optimum orientation of the mean linear profile of the axially exterior major grooves according to the most penalizing stress loading. Therefore, for a tire that has a recommended direction of rotation, it is possible to choose the optimum orientation of the mean linear profile of the axially exterior major grooves, with respect to the bisector of the reinforcing elements of the two working layers, according to whether they are positioned on the right-hand side or on the left-hand side of the tire. Optimizing the grooves in the left-hand portion of the tire will be done for stress loadings resulting from a right-hand bend, and vice versa.

For a left-hand bend, the tire will, in the crown and therefore in the working layers, experience a force from the ground oriented to the left, whereas this force is compensated for in the lower sidewall region of the tire in contact with the rim by a force to the right resulting from the centrifugal force applied to the vehicle. Away from the contact patch in which the tread surface is in contact with the ground, the forces on the tread are zero. The transverse forces increase from the point of entry into the contact patch to the point of exit, as do the associated bending moments. They are at a maximum just before the slip zone, before exiting the contact patch.

For a left-hand bend, a right-handed working layer, of which the end on the right-hand side of the tire enters the contact patch before the left-hand end, is deformed in such a way that its angle on leaving the contact patch, where compression is at a maximum, diverges away from the circumferential direction which is the direction of compression. By contrast, for a left-handed working layer, the reinforcing elements thereof deform in such a way as to be oriented in the circumferential direction which is the direction of compression. It is therefore the reinforcing elements in the left-handed working layer which experience the greatest compressive loadings and will be the most sensitive to fatigue. It is therefore necessary to avoid the mean linear profile of the axially exterior major grooves of the right-hand portion of the tire being perpendicular to the deformed form of the reinforcing elements of the left-handed working layer. That implies that the angle C′ between the circumferential axis (XX′) and the vector (ab) of the mean linear profile of the axially exterior major grooves of the right-hand portion of the tire needs to be at most equal to (−85°+(AA+AB)/2).

For a right-hand bend, using analogous reasoning, the angle C between the circumferential axis (XX′) and the vector (ab) of the mean linear profile of the axially exterior major grooves of the left-hand portion of the tire needs to be at least equal to (85°+(AA+AB)/2).

Passenger vehicles are not intended to reach high transverse accelerations in reverse gear and this means that the compressive stress loadings do not generate any buckling of the reinforcing elements of the working layers.

For preference, in order to improve the endurance of the reinforcing elements of the working layers still further, it is possible to restrict the admissible interval for the angles C and C′ of the mean linear profiles L of any axially exterior major groove of the right-hand and left-hand parts of the tire still further and to also take into consideration the angle criterion not only regarding the most highly stressed working layer but also regarding the least stressed layer. Thus, for preference, the vector (ab) of any mean linear profile L of any axially exterior major groove of the left-hand axially exterior portion of the tread forms, with the circumferential direction (XX′) of the tire, an oriented angle C (XX′; ab) at least equal to (90°+(AA+AB)/2), and at most equal to (120°+(AA+AB)/2), and the vector (ab) of any mean linear profile L of any axially exterior major groove (24) of the right-hand axially exterior portion (22) of the tread (2) forms, with the circumferential direction (XX′) of the tire, an oriented angle C′ (XX′; ab) at most equal to (−90°+(AA+AB)/2), and at least equal to (−120°+(AA+AB)/2).

The two axially exterior portions of the tread may potentially contain one or more circumferential grooves in order to reduce the risk of aquaplaning on wet ground. For passenger vehicle tires, these circumferential grooves generally represent a small width of the contact patch and have no known impact on the buckling of the monofilaments.

The major grooves may also contain protuberances or bridges, these bridges being potentially able to contain a sipe with a mean width of less than 1 mm.

The monofilaments may have any cross-sectional shape, in the knowledge that oblong cross sections represent an advantage over circular cross sections, even when of smaller size, because their inertia in bending and, therefore, their resistance to buckling, are higher. In the case of a circular cross section, the smallest dimension corresponds to the diameter of the cross section. In order to guarantee the fatigue breaking strength of the monofilaments and the resistance to shearing of the rubber compounds situated between the filaments, the density of reinforcing elements of each working layer is at least equal to 100 threads per dm and at most equal to 200 threads per dm. What is meant by the density is the mean number of monofilaments over a 10-cm width of the working layer, this width being measured perpendicularly to the direction of the monofilaments in the working layer considered. The distance between consecutive reinforcing elements may be fixed or variable. The reinforcing elements may be laid during manufacture either in layers, in strips, or individually.

It is advantageous for any axially exterior major groove to have a width W at most equal to 10 mm so as to limit the void volume of the tread and preserve the wearability of the tire.

For preference, any axially exterior major groove has a depth D at most equal to 8 mm. This is because beyond a certain thickness, the tread becomes too flexible and the tire does not perform so well in terms of wear, behaviour and rolling resistance.

For preference, the axially exterior major grooves are spaced apart, in the circumferential direction (XX′) of the tire, by a circumferential spacing P at least equal to 8 mm, in order to avoid excessive flexibility of the tread and loss of wearing and rolling-resistance performance. The circumferential spacing is the mean circumferential distance, over the relevant axially outermost portion of the tread, between the mean linear profiles of two circumferentially consecutive axially exterior major grooves. Usually, the treads of tires may have circumferential spacings that are variable notably so as to limit road noise.

One preferred solution is for the axially exterior major grooves to be spaced apart, in the circumferential direction (XX′) of the tire, by a circumferential spacing P at most equal to 50 mm, in order to guarantee good grip on wet ground.

It is particularly advantageous for the bottom face of an axially exterior major groove to be positioned radially on the outside of the crown reinforcement at a radial distance D1 at least equal to 1.5 mm. This is because this minimal quantity of rubbery material protects the crown from attack and puncturing by obstacles, stones, or any debris lying on the ground.

It is preferable for the radial distance between the bottom face of the axially exterior major grooves and the radially outermost reinforcing elements of the crown reinforcement to be at most equal to 3.5 mm in order to obtain a tire that performs well in terms of rolling resistance.

For preference, at least one axially exterior portion, comprising axially exterior major grooves, comprises sipes having a width W1 at most equal to 1 mm. In order to improve grip on certain types of ground, notably on ground covered with black ice or snow, it is possible to provide small-width sipes in the axially exterior portions of the tread, without impairing the endurance of the tire the working reinforcement of which contains monofilaments. This is because when these sipes enter the contact patch, their main profiles come into contact with one another and the rubbery material of the tread then absorbs the compressive loadings. These sipes may have widths that are variable in the direction of the main profiles or in their depth as long as their minimum width is at most equal to 1 mm over a sufficient surface area, for example at least equal to 50 mm².

It is also possible to provide grooves of small depth, smaller than 5 mm, without significantly impairing the endurance of the tire, although, in this case, the performance, notably the wet grip performance, becomes degraded as the tire wears.

Advantageously, the two axially exterior portions of the tread each have an axial width (LG, LD) at most equal to 0.2 times the axial width LT of the tread.

It is advantageous for the two working layers to be crossed and for the angles of the respective reinforcing elements of the working layers to be equal in terms of absolute value. This embodiment offers advantages in terms of manufacture, product standardization, and therefore production costs. This equality of the angles is satisfied to within the manufacturing tolerances, namely to within plus or minus 2°.

One preferred solution is for each working layer to comprise reinforcing elements which form, with the circumferential direction (XX′) of the tire, an angle at least equal to 22° and at most equal, in absolute value, to 35°, which constitute an optimal compromise between tire behaviour and tire endurance performance.

For preference, each working layer comprises reinforcing elements made up of individual metal threads or monofilaments having a cross section S the smallest dimension of which is at least equal to 0.3 mm and at most equal to 0.37 mm, which constitute an optimum for balancing the target performance aspects: weight saving and buckling endurance of the reinforcing elements of the working layers.

The reinforcing elements of the working layers may or may not be rectilinear. They may be preformed, of sinusoidal, zigzag, or wavy shape, or following a spiral. The reinforcing elements of the working layers are made of steel, preferably carbon steel such as those used in cords of the “steel cords” type, although it is of course possible to use other steels, for example stainless steels, or other alloys.

When a carbon steel is used, its carbon content (% by weight of steel) is preferably comprised in a range from 0.8% to 1.2%. The invention is particularly applicable to steels of the very high strength “SHT” (“Super High Tensile”), ultra-high strength “UHT” (“Ultra High Tensile”) or “MT” (“Mega Tensile”) steel cord type. The carbon steel reinforcers then have a tensile breaking strength (Rm) preferably at least equal to 3000 MPa, more preferably at least equal to 3500 MPa. Their total elongation at break (At), which is the sum of the elastic elongation and the plastic elongation, is preferably at least equal to 2.0%.

As far as the steel reinforcers are concerned, the measurements of breaking strength, denoted Rm (in MPa), and elongation at break, denoted At (total elongation in %), are taken under tension in accordance with ISO standard 6892 of 1984.

The steel used, whether it is in particular a carbon steel or a stainless steel, may itself be coated with a layer of metal which improves for example the workability of the steel monofilament or the wear properties of the reinforcer and/or of the tire themselves, such as properties of adhesion, corrosion resistance or even resistance to ageing. According to one preferred embodiment, the steel used is covered with a layer of brass (Zn—Cu alloy) or of zinc; it will be recalled that, during the process of manufacturing the wire threads, the brass or zinc coating makes the wire easier to draw, and makes the wire thread adhere to the rubber better. However, the reinforcers could be covered with a thin layer of metal other than brass or zinc, having for example the function of improving the corrosion resistance of these threads and/or their adhesion to the rubber, for example a thin layer of Co, Ni, Al, of an alloy of two or more of the Cu, Zn, Al, Ni, Co, Sn compounds.

It is advantageous for the density d of reinforcing elements in each working layer to be at least equal to 120 threads per dm and at most equal to 180 threads per dm in order to guarantee improved endurance of the rubber compounds working in shear between the reinforcing elements and the tension and compression endurance thereof.

For preference, the reinforcing elements of the at least one hooping layer are made of textile, preferably of aliphatic polyamide, aromatic polyamide or combination of aliphatic polyamide and of aromatic polyamide, polyethylene terephthalate or rayon type, because textile materials are particularly well-suited to this type of use because of their low mass and high rigidity. The distance between consecutive reinforcing elements in the hooping layer, or spacing, may be fixed or variable. The reinforcing elements may be laid during manufacture either in layers, in strips, or individually.

It is advantageous for the hoop reinforcement to be radially on the outside of the working reinforcement in order to ensure good endurance of the latter.

### BRIEF DESCRIPTION OF THE DRAWINGS

The features and other advantages of the invention will be understood better with the aid of FIGS. 1 to 9, the said figures being drawn not to scale but in a simplified manner so as to make it easier to understand the invention:

FIG. 1 is a perspective view depicting a tire that has a recommended direction of rotation (SR).

FIG. 2 depicts part of a tire according to the invention, particularly its architecture and its tread.

FIG. 3 depicts a meridian section through the crown of a tire according to the invention and illustrates the axially exterior portions 22 and 23 of the tread, and the respective axial widths LG and LD thereof.

FIGS. 4A and 4B depict two types of radially exterior meridian profile of the tread of a passenger vehicle tire.

FIG. 5 illustrates various possible types of axially exterior groove 24.

FIG. 6A illustrates the optimum intervals I for the angle C between the circumferential direction XX′ and the direction of the mean linear profile L of any axially exterior major groove, [90°+(AA+AB)/2−30; 90°+(AA+AB)/2+30] mod(180°), for a tire without a recommended direction of rotation. FIG. 6B illustrates the optimum respective intervals IG and ID for the angles C and C′ between the circumferential direction XX′ and the direction of the mean linear profiles L of any axially exterior major groove of the left-hand portion PG and of the right-hand portion PD of the tire, respectively.

FIG. 7A illustrates the effect of a left-hand bend on a reinforcing element of a right-handed working layer in the contact patch, and FIG. 7B illustrates the effect of a left-hand bend on a reinforcing element of a left-handed working layer in the contact patch.

FIG. 8A illustrates a type of tread pattern that is not optimized by the invention, and FIG. 8B illustrates a type of tread pattern that is optimized by the invention with a recommended direction of rotation.

FIGS. 9A, 9B, 9C illustrate a method for determining the profiles of the grooves in the case of a network of grooves.

### DETAILED DESCRIPTION OF THE DRAWINGS

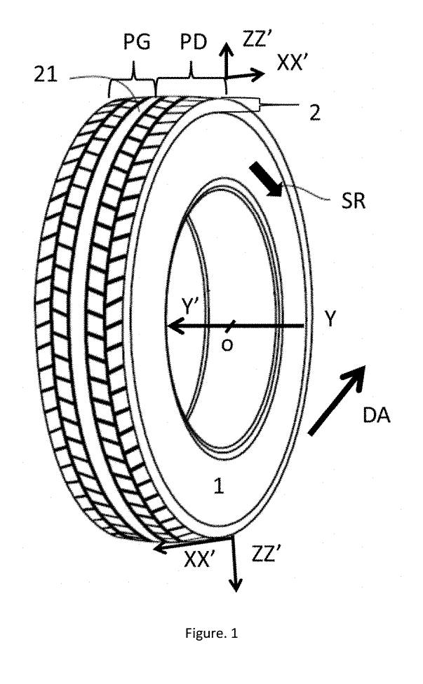

FIG. 1 depicts a perspective view of a tire (1) having a tread (2) and a direction of rotation (SR) recommended by the manufacturer and usually indicated by an arrow on a sidewall. When rotating about its axis YY′, in the direction of rotation (SR), the tire moves in the direction of forward travel (DA). The anticlockwise cylindrical frame of reference (O, XX′, YY′, ZZ′) is chosen such that the direction vector for the circumferential direction XX′ is always oriented in the recommended direction of rotation (SR). The circumferential median plane of the tire (XX′, ZZ′), which passes through the middle of the tread and is perpendicular to the axis of rotation YY′, and the direction vector for the circumferential direction XX′, oriented in the direction of rotation (SR) that gives the direction of forward travel (DA), make it possible to determine two half-torus shapes, respectively referred to as the left-hand portion (PG), the points of which have positive coordinates in the axial direction YY′, and the right-hand portion (PD) of the tire, the points of which have negative coordinates in the axial direction YY′. The tread comprises a tread surface (21) intended to come into contact with the ground. Also depicted are frames of reference (O, XX′, YY′, ZZ′) associated with meridian planes having different angular positions about the axis of rotation YY.

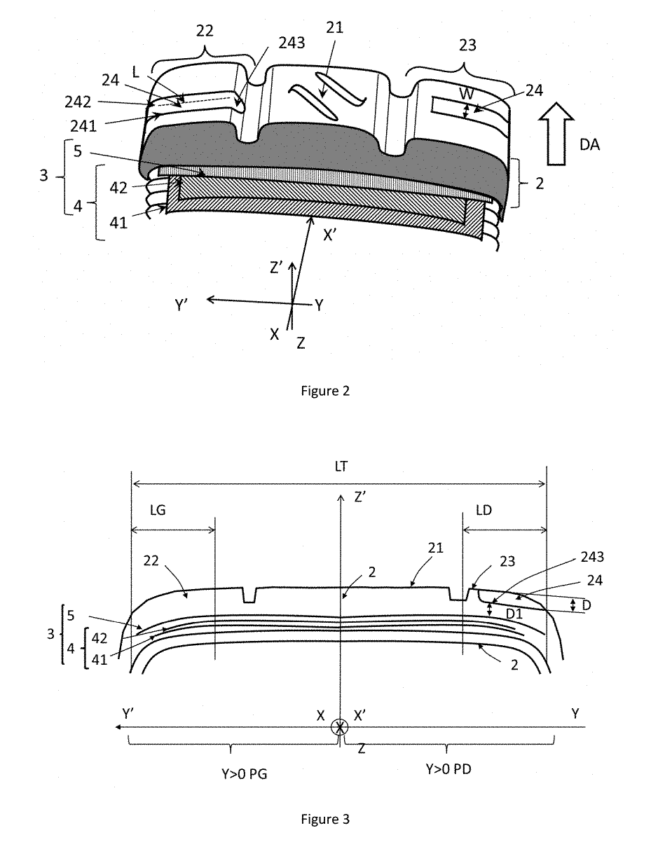

FIG. 2 depicts a perspective view of a part of the crown of a tire. A plane of reference (O, XX′, YY′, ZZ′) is associated with each meridian plane. The tire comprises a tread 2 which is intended to come into contact with the ground via a tread surface 21. Arranged in the respectively left-hand 22 and right-hand 23 axially exterior portions of the tread are axially exterior grooves 24 of width W each having main profiles 241 and 242 and a bottom face 243 and having a mean linear profile L. The tire further comprises a crown reinforcement 3 comprising a working reinforcement 4 and a reinforcement 5. The working reinforcement comprises two working layers 41 and 42 each comprising mutually parallel reinforcing elements, one of them being a right-handed working layer and the other a left-handed working layer.

FIG. 3 is a schematic meridian section through the crown of the tire according to the invention. It illustrates in particular the axial widths LG and LD of the left-hand 22 and right-hand 23 axially exterior portions of the tread, and the total axial width of the tread of the tire LT. The depth D of an axially exterior groove 24, and the distance D1 between the bottom face 243 of an axially exterior groove 24 and the crown reinforcement 3, measured along a meridian section of the tire, are also depicted. A meridian section of the tire is obtained by cutting the tire on two meridian planes.

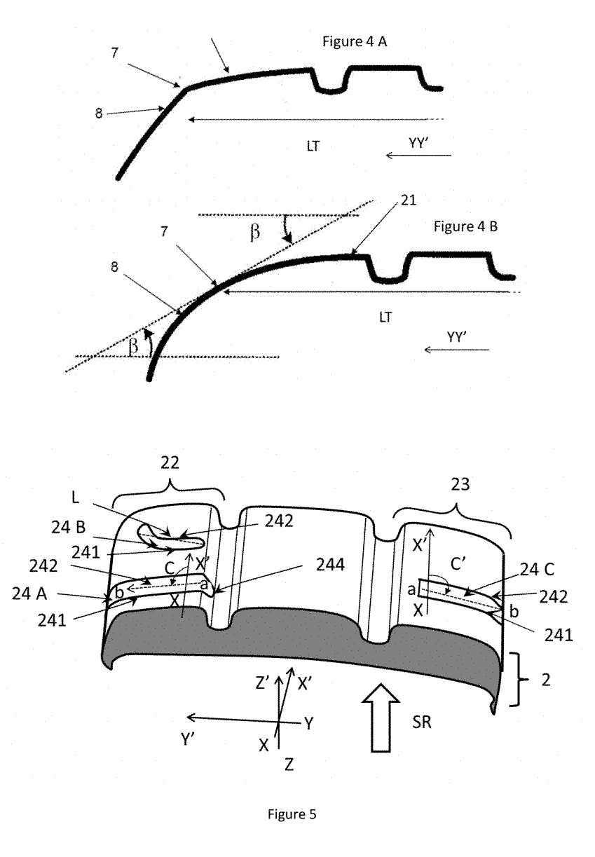

In FIGS. 4A and 4B, the axial edges 7 of the tread, that make it possible to measure the axial width of the tread, are determined. In FIG. 4A, in which the tread surface 21 is secant with the exterior axial surface of the tire 8, the axial edge 7 is determined by a person skilled in the art in a trivial way. In FIG. 4B, in which the tread surface 21 is continuous with the exterior axial surface of the tire 8, the tangent to the tread surface at any point on the said tread surface in the region of transition towards the sidewall is plotted on a meridian section of the tire. The first axial edge 7 is the point for which the angle β (beta) between the said tangent and an axial direction YY′ is equal to 30°. When there are several points for which the angle β between the said tangent and an axial direction YY′ is equal to 30°, it is the radially outermost point that is adopted. The same approach is used to determine the second axial edge of the tread.

FIG. 5 schematically depicts axially exterior grooves 24 in a tread 2. A person skilled in the art determines the main profiles 241 and 242 of the grooves, which are distant from one another by a distance W. These profiles are linearized into a mean linear profile L by linear interpolation of the profiles in the axial direction YY′. The axially innermost point a and the axially outermost point b of the mean linear profile L respectively define the origin and the end of the vector ab. These vectors make it possible to define the oriented angles C (XX′; ab) of the mean linear profiles that the grooves 24 make with the circumferential direction XX′ in the left-hand 22 and right-hand 23 axially exterior portions of the tread. The grooves may be open-ended like the groove 24A, blind like the groove 24C or double-blind like the groove 24B.

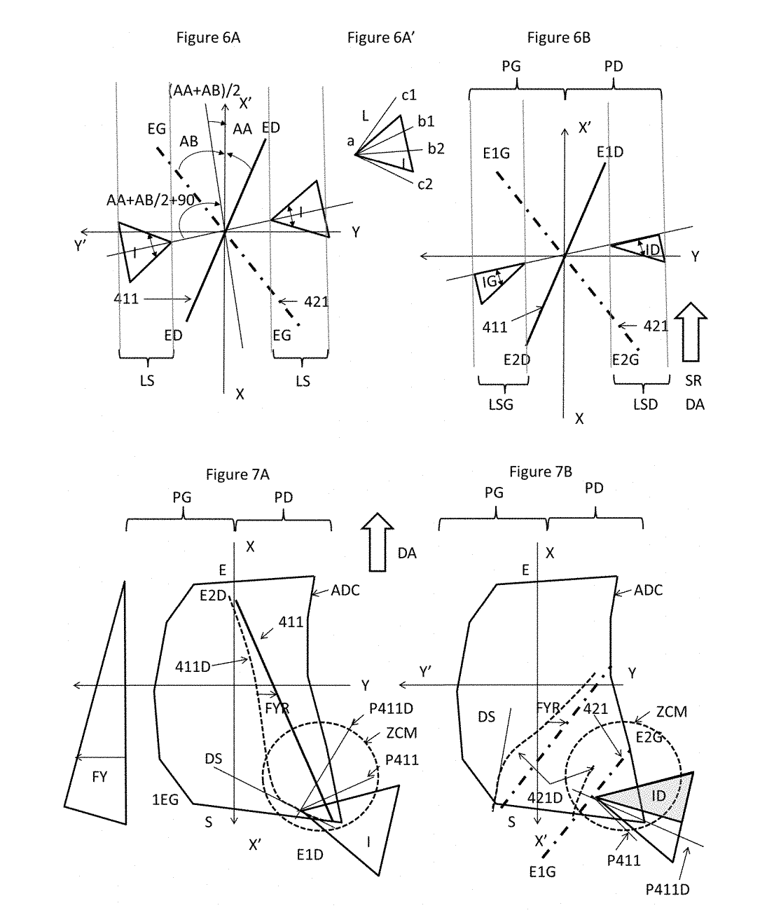

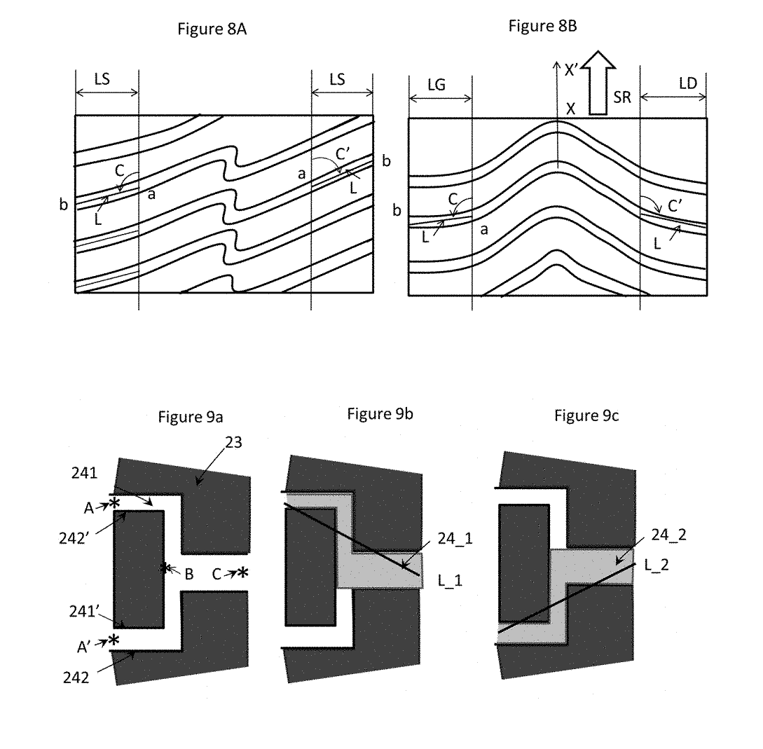

FIG. 6A illustrates, for a tire with no recommended direction of rotation, the cones I of the optimum directions of the mean linear profile L of any axially exterior major groove: an optimal angle C, between the circumferential axis and the direction of the mean linear profile L, belongs to the interval [90+(AA+AB)/2−30; 90+(AA+AB)/2+30] mod (180). A reinforcing element of a right-handed working layer 411 is depicted with its ends ED making an oriented angle AA with the circumferential axis XX′, and a reinforcing element of a left-handed working layer 421 making an oriented angle AB with the circumferential axis XX′. The mediator of these two angles (AA+AB)/2 makes it possible to define the interval for the optimal angles for the directions of the mean linear profiles of the major exterior grooves about its perpendicular (AA+AB)/2+90°, to plus or minus 30°. Rotating FIG. 6A through 180° has no impact on how it is depicted because the direction of rotation of the tire has no influence.

FIG. 6A′ illustrates the meaning of the cone I. For a profile L, of interior axial end a, the angle at a of the cone is equal to 60°, the mediator of the cone makes, with the circumferential axis, an angle of (AA+AB)/2+90° for the left-hand portion of the tire, and an angle of (AA+AB)/2−90° for the right-hand portion. If the exterior axial end of the mean linear profile of the groove, c1 or c2, is such that the direction ac1 or ac2 does not lie inside the cone, then the groove does not meet the groove optimization conditions. If the exterior axial end of the mean linear profile of the groove, b1 or b2, is such that the direction ab1 or ab2 lies inside the cone, then the groove meets the groove optimization conditions, not within the sense of the invention but for the case of a tire that has no recommended direction of rotation.

By adopting a recommended direction of rotation SR of the tire, it is possible to optimize endurance still further, and FIG. 6B illustrates the optimum cones IG and ID for the directions of the mean linear profiles L of any axially exterior major groove. The angles of the mean linear profiles L of any axially exterior major groove in the left-hand portion (PG) of the tire with the circumferential axis XX′, are at least equal to 90°+(AA+AB)/2, and at most equal to 90°+(AA+AB)/2+30°. The angles of the mean linear profiles L of any axially exterior major groove in the right-hand portion of the tire with the circumferential axis XX′, are at most equal to −90°+(AA+AB)/2, and at least equal to −90°+(AA+AB)/2−30°. In this case, with a recommended direction of rotation and following this recommendation, the end E1G of the left-handed reinforcing element 421 is always first, in forwards running, in bends with a high transverse acceleration, to enter the contact patch as compared with the end E2G, and likewise the end E1D of the right-handed reinforcing element is first to enter the contact patch as compared with the end E2D. Rotating FIG. 6B by 180° influences the positions of the optimal intervals IG and ID, and therefore of the grooves with regard to entering the contact patch.

FIG. 7A illustrates, viewed from the axis of rotation, the effect of a left-hand bend on a reinforcing element 411 of a right-handed working layer in the contact patch. The entry to the contact patch is denoted by E, the exit by S and the direction of forward travel is DA. The tire, subjected to transverse loading, is placed in bending. The zone of maximum compression ZCM in the direction XX′ is at the exit from the contact patch in the right-hand portion. The end E1D of the reinforcing element 411 that is first to enter the contact patch and therefore near the exit, is significantly to the right of the end 2ED. This latter end, which enters later, is near the entry of the contact patch.

The reinforcing element under consideration is subjected to a force FY from the ground onto the tire, which is zero at the entry to the contact patch and that increases as the tread becomes progressively sheared until it reaches a maximum after which it decreases because of the slippage on exiting the contact patch. This force deforms the reinforcing element 411 to 411D, giving it a direction closer to XX′, and generating a return force FYR that increases from the entry to the contact patch as far as the slip zone at the exit from the contact patch. At the exit of the contact patch, the force FY of the ground on the tire decreases because of the slippage when the return force FYR caused by deformation of the crown and of the reinforcing elements is at a maximum, and so the reinforcing element returns as quickly as possible to a position in a direction DS that is near-perpendicular to the direction XX′, which is the direction of the bending compression. Therefore, the reinforcing element absorbs only a very small amount of compression and, at this working layer, the compression forces are absorbed by the rubbery compound of the matrix. It is therefore not for the benefit of the reinforcing elements of the right-handed layers that the tread pattern needs to be optimized in a left-hand bend.

Conversely, FIG. 7B illustrates, viewed from the axis of rotation, the effect of that same left-hand bend on a reinforcing element 421 of a left-handed working layer in the contact patch. The end E1G of the reinforcing element 421 that is first to enter the contact patch has left the contact patch. It is well to the right of the end E2D that entered later and is still in the contact patch. This reinforcing element is subjected to the force FY from the ground onto the tire, which is zero at the entry to the contact patch and that increases as the tread becomes progressively sheared until it reaches a maximum and then decreases because of the slippage on exiting the contact patch. This force deforms the reinforcing element 421 at 421D, giving it a direction closer to YY′, and generating a return force FYR that increases from the entry to the contact patch as far as the slip zone at the exit from the contact patch. On leaving the contact patch, the force FY of the ground on the tire decreases when the return force FYR is at a maximum, and so the reinforcing element therefore quickly returns to a position that makes a direction DS near-parallel to the direction XX′, which is the direction of maximum compression caused by the flexing of the crown under the effect of the transverse force. The reinforcing element therefore absorbs all of the compression. In order to avoid the axially exterior major grooves of the right-hand part PD being perpendicular to the deformed form of the deformed reinforcing element, thus encouraging it to buckle, it is necessary that the perpendicular P411D to the deformed form 411D at the zone of maximum compression should not belong to the cone ID allowed for the vectors ab of the mean linear profiles of the axially exterior grooves. Therefore, in order to avoid buckling of the reinforcing elements of this working layer, in the right-hand portion of the tire, the vectors ab of the mean linear profiles of the axially exterior grooves need to make, with the circumferential axis XX′, an oriented angle C′ at most equal to −90°+(AA+AB)/2, and at least equal to (−90°+(AA+AB)/2)−30°, namely −120°+(AA+AB/2).

Similar reasoning makes it possible, for a right-hand bend, to determine the optimum angle for the axially exterior grooves of the left-hand portion of the tire in order to preserve the reinforcing elements of the right-handed working layer from buckling. Therefore, in the left-hand portion of the tire, the vectors ab of the mean linear profiles of the axially exterior grooves need to make, with the circumferential axis XX′, an oriented angle C belonging to IG, namely at least equal to 90°+(AA+AB)/2, and at most equal to 90°+(AA+AB)/2+30°, namely 120°+(AA+AB/2).

FIGS. 9A, 9B, 9C illustrate a method for determining the major grooves in the case of a network of grooves. For certain tread patterns, grooves open into other grooves as illustrated in FIG. 9A. In that case, the lateral faces of the network which are the continuous lateral faces most circumferentially distant from one another in the network of grooves will be determined, which in the present case are the lateral faces 241 and 242. The invention will be applied to all the grooves which, as their lateral faces, have one of the lateral faces of the network and the directly adjacent opposite lateral face. Let us therefore consider here the groove 24_1 (FIG. 9B), of mean linear profile L_1, made up of the lateral face of the network 241 and the opposite lateral face directly adjacent to (241, 242′), over a first portion leading from point A to point B, and of the lateral face of the network 241 and the opposite lateral face 242 directly adjacent to 241, over a second portion leading from point B to point C. Next, consider the groove 24_2 (FIG. 9C), of mean linear profile L_2, made up of the lateral face of the network 242 and the opposite lateral face 241′ directly adjacent to 242, over a first portion leading from point A to point B, and of the lateral face of the network 242 and the opposite lateral face 241 directly adjacent to 242, over a second portion leading from point B to point C. For more complex networks, this rule will be generalized so that all of the possible major grooves of the network substantially following the orientation of the lateral faces of the network satisfy the characteristics of the invention.

The inventors have performed calculations on the basis of the invention for a tire of size 205/55 R16, inflated to a pressure of 2 bar, comprising two working layers comprising steel monofilaments of diameter 0.3 mm, distributed at a density of 158 monofilaments to the dm and forming, with the circumferential direction, the angles A1 and A2 respectively equal to +27° and −27°. The monofilaments have a breaking strength Rₘ equal to 3500 MPa and the working layers each have a breaking strength R_{c} equal to 39 000 N/dm. The tire comprises axially exterior major grooves of the blind type of a depth of 6.5 mm, on the two axially exterior portions of the tread of the tire having an axial width equal to 0.21 times the axial width of the tread, distributed at a circumferential spacing of 30 mm. The radial distance D1 between the bottom face of the axially exterior major grooves and the crown reinforcement is at least equal to 2 mm.

Various tires were calculated and tested, varying the angles C and C′ of the mean linear profile of the axially exterior major grooves with respect to the circumferential direction in the left-hand and right-hand portions of the tire respectively:
Tire A, according to the invention, characterized by having angles C and C′ of the mean linear profile of the axially exterior major grooves with respect to the circumferential direction XX′, in the left-hand and right-hand portions of the tire, of 90° and −90° respectively
Tire B, according to the invention, characterized by having angles C and C′ of 120° and −120° respectively.
Tire C, excluded from the invention, characterized by having angles C and C′ of 60° and −60° respectively.

The conditions used for the calculation reproduce the running conditions of a front tire on the outside of the bend, namely the tire that is most heavily loaded in a passenger vehicle. These loadings, for a lateral acceleration of 0.7 g, are as follows: a load (Fz) of 749 daN, a lateral load (Fy) of 509 daN and a camber angle of 3.12°, corresponding to a left-hand bend. The following table gives the maximum of the bending stress loadings in the monofilaments as a function of the tire in the left-handed working layer which is the working layer most heavily loaded in a left-hand bend. These maximum values are referenced with respect to the value determined for tire A according to the invention. The tires calculated were run on an 8.5 m rolling road under the same conditions and running was interrupted at regular intervals to take nondestructive measurements in order to check for the presence of breakages in the reinforcing elements of the working layers. The distance covered before the monofilaments in a working layer, in this instance the left-handed working layer, broke is given in Table I below.

TABLE I

| | Tire | | |
|---|---|---|---|
| | A | | |
| | (according | B | C |
| | to the | (according to the | (excluded from |
| | invention) | invention) | the invention) |
| Angles C and C′ | 90° C. and | 120° C. and −120° C. | 60 and −60° |
| | −90° C. | | |
| Maximum bending | 100 | 98 | 166 |
| stress (base 100) by | | | |
| calculation | | | |
| Distance covered | 100 | 100 | 65 |
| before breaking | | | |
| (base 100) by | | | |
| calculation | | | |

By calculation, the minimum bending stress is reached in tires A and B according to the invention. In testing on tires, the maximum distance covered before the monofilaments in the left-handed working layer broke is also reached in tires A and B according to the invention. Tire C, excluded from the invention, has a significantly lower distance covered before breakage.

Two tires A′ and B′, of the same size 205/55 R16, with the same architecture as tires A and B and with tread patterns that were mutually identical apart from the angles C and C′, were also tested using the same procedure, simulating a left-hand bend and a right-hand bend as the case may be.
A′, according to the invention, is such that the vectors ab of any mean linear profile L of any axially exterior major groove of, respectively the left-hand and the right-hand axially exterior portion of the tread form, with the circumferential direction (XX′) of the tire, oriented angles C and C′ equal respectively to 102° and −102°
B′, excluded from the invention, is such that the vectors ab of any mean linear profile L of any axially exterior major groove of, respectively the left-hand and the right-hand axially exterior portion of the tread form, with the circumferential direction (XX′) of the tire, oriented angles C and C′ equal respectively to 78° and −78°

The rolling-road running was interrupted at regular intervals to take nondestructive measurements in order to check for the presence of breakages in the reinforcing elements of the most heavily loaded working layer of the tire, according to the direction of the bend. The distance covered before monofilament breakage started to appear is given in the following Table II, to base 100 with respect to the distance covered by tire A′ according to the invention, the endurance performance of which is, in both instances, superior, regardless of the direction of the bend.

TABLE II

| Distance covered before | | |
|---|---|---|
| monofilament breakages | A′ | B′ |
| started to appear, to base | (according to | (excluded from |
| 100 | the invention) | the invention) |
| Right-hand bend | 100 | 65 |
| Left-hand bend | 100 | 50 |

1. A tire for a passenger vehicle, adapted to be mounted on a rim in a recommended direction of rotation orientating a circumferential direction, comprising:
with respect to the circumferential direction oriented in the recommended direction of rotation, a left-hand part and a right-hand part extending axially and symmetrically from a circumferential median plane, passing through the middle of a tread of the tire, intended to come into contact with the ground via a tread surface, and perpendicular to an axis of rotation of the tire,
the tread comprising two axially exterior portions, belonging respectively to the left-hand part and to the right-hand part of the tire, each respectively having an axial width at most equal to 0.3 times the axial width LT,
at least one axially exterior portion of the tread comprising axially exterior grooves, an axially exterior groove forming a space opening onto the tread surface and being delimited by at least two main lateral faces connected by a bottom face,
at least one axially exterior groove open, referred to as major groove, having a width W, defined by the distance between the two main lateral faces, at least equal to 1 mm, a depth D, defined by the maximum radial distance between the tread surface and the bottom face, at least equal to 5 mm, and a mean linear profile, having an axially innermost point and an axially outermost point which define the vector of the mean linear profile,
the tire radially on the inside of the tread, and comprising a working reinforcement and a hoop reinforcement,
the working reinforcement comprising at least two working layers each comprising reinforcing elements which are coated in an elastomeric material, mutually parallel and respectively form, with a circumferential direction of the tire, two oriented angles AA and AB in the counterclockwise direction at least equal to 20° and at most equal to 50°, in terms of absolute value, and of opposite sign from one layer to the next,
said reinforcing elements in each said working layer being comprised of individual metal threads or monofilaments having a cross section S the smallest dimension of which is at least equal to 0.20 mm and at most equal to 0.5 mm, and a breaking strength Rm,
the density d of monofilaments in each working layer being at least equal to 100 threads per dm and at most equal to 200 threads per dm,
the hoop reinforcement comprising at least one hooping layer comprising reinforcing elements which are mutually parallel and form, with the circumferential direction of the tire, an angle at most equal to 10°, in terms of absolute value,
wherein the vector of any mean linear profile of any axially exterior major groove of the left-hand axially exterior portion of the tread forms, with the circumferential direction of the tire, an oriented angle C at least equal to (85°+(AA+AB)/2),
wherein the vector of any mean linear profile of any axially exterior major groove of the right-hand axially exterior portion of the tread forms, with the circumferential direction of the tire, an oriented angle C′ at most equal to (−85°+(AA+AB)/2)), and
wherein the breaking strength R_{C} of each said working layer is at least equal to 30 000 N/dm, Rc being defined by: Rc=Rm*S*d, where Rm is the tensile breaking strength of the monofilaments in MPa, S is the cross-sectional area of the monofilaments in mm² and d is the density of monofilaments in the working layer considered, in number of monofilaments per dm.

2. The tire according to claim 1, wherein the vector of any mean linear profile L of any axially exterior major groove of the left-hand axially exterior portion of the tread forms, with the circumferential direction of the tire, an oriented angle C at least equal to (90°+(AA+AB)/2), and at most equal to (120°+(AA+AB)/2), and the vector of any mean linear profile of any axially exterior major groove of the right-hand axially exterior portion of the tread forms, with the circumferential direction of the tire, an oriented angle C′ at most equal to (−90°+(AA+AB)/2), and at least equal to (−120°+(AA+AB)/2).

3. The tire according to claim 1, wherein any said axially exterior major groove has a width W at most equal to 10 mm.

4. The tire according to claim 1, wherein any said axially exterior major groove has a depth D at most equal to 8 mm.

5. The tire according to claim 1, wherein the axially exterior major grooves are spaced apart, in the circumferential direction of the tire, by a circumferential spacing P at least equal to 8 mm.

6. The tire according to claim 1, wherein the axially exterior major grooves are spaced apart, in the circumferential direction of the tire, by a circumferential spacing P at most equal to 50 mm.

7. The tire according to claim 1, wherein the bottom face of an axially exterior major groove is positioned radially on the outside of the crown reinforcement at a radial distance D1 at least equal to 1.5 mm.

8. The tire according to claim 1, wherein the bottom face of an axially exterior major groove is positioned radially on the outside of the crown reinforcement at a radial distance D1 at most equal to 3.5 mm.

9. The tire according to claim 1, wherein at least one axially exterior portion, comprising axially exterior major grooves, comprises sipes having a width W1 at most equal to 1 mm.

10. The tire according to claim 1, wherein the two axially exterior portions each have an axial width at most equal to 0.2 times the axial width LT of the tread.

11. The tire according to claim 1, wherein the angles of the reinforcing elements of the working layers are equal in terms of absolute value.

12. The tire according to claim 1, wherein each said working layer comprises reinforcing elements which form, with the circumferential direction of the tire, an angle at least equal to 22° and at most equal to 35° in terms of absolute value.

13. The tire according to claim 1, wherein each said working layer comprises reinforcing elements comprised of individual metal threads or monofilaments having a diameter at least equal to 0.3 mm and at most equal to 0.37 mm.

14. The tire according to claim 1, wherein the reinforcing elements of the working layers are made of steel.

15. The tire according to claim 1, wherein the density of reinforcing elements in each working layer is at least equal to 120 threads per dm and at most equal to 180 threads per dm.

16. The tire according to claim 1, wherein the reinforcing elements of the at least one hooping layer are made of textile.

17. The tire according to claim 1, wherein the hoop reinforcement is radially on the outside of the working reinforcement.

18. The tire according to claim 1, wherein the reinforcing elements of the working layers are made of carbon steel.

19. The tire according to claim 1, wherein the reinforcing elements of the at least one hooping layer are made of aliphatic polyamide, aromatic polyamide or combination of aliphatic polyamide and of aromatic polyamide, polyethylene terephthalate or rayon type.
